(19) United States
(12) Patent Application Publication
(10) Pub. No.: US 2024/0122128 A1
(43) Pub. Date: Apr. 18, 2024

(54) Method to Reduce the Intensity of Hurricanes Using Submarines to Spray Liquid Nitrogen

(71) Applicant: Vasudevacharya Jayarama, Framingham, MA (US)

(72) Inventor: Vasudevacharya Jayarama, Framingham, MA (US)

(21) Appl. No.: 18/235,182

(22) Filed: Aug. 17, 2023

Related U.S. Application Data
(60) Provisional application No. 63/373,989, filed on Aug. 30, 2022.

(51) Int. Cl. A01G 15/00

(52) U.S. Cl. CPC A01G 15/00

(57) ABSTRACT

Submarines have been used mainly as weapons so far. Here, a method is proposed wherein they are used for a peaceful and noble purpose of reducing the intensity of hurricanes. It is proposed that the intensity of hurricanes can be reduced by spraying liquid nitrogen at the advancing inner rim of the hurricane eye walls at the sea surface using submarines. Spraying liquid nitrogen is expected to serve two purposes: (1) cool a targeted area of the ocean to make the conditions unfavorable for the advancing hurricane, and (2) slow down and disrupt the flow of air in the eye wall by the heavy and dry mass of the vaporized liquid nitrogen. By using a sufficient amount of liquid nitrogen and/or by combining this method with other method/s of hurricane control, it might be possible to completely disrupt and disintegrate a hurricane altogether.

### SUMMARY

Submarines have been used mainly as weapons so far. Alternately, there are reports of them being used for illegitimate purposes, such as drug smuggling. Here, a method is proposed wherein they are used for a peaceful and a noble purpose of reducing the intensity of hurricanes. It is proposed that the intensity of hurricanes can be reduced by spraying liquid nitrogen at the advancing inner rim of the hurricane eye walls at the sea surface using submarines. Spraying liquid nitrogen is expected to serve two purposes: (1) cool a targeted area of the ocean to make the conditions unfavorable for the advancing hurricane, and (2) slow down and disrupt the flow of air in the eye wall by the heavy and dry mass of the vaporized liquid nitrogen. By using sufficient amount of liquid nitrogen and/or by combining this method with other method/s of hurricane control, it might be possible to completely disrupt and disintegrate a hurricane altogether.

### OBJECTIVE

Spraying liquid nitrogen at the advancing inner rim of the hurricane eyewall to cool down the surface water as well as disrupt the smooth flow of moisture laden air in the hurricane eyewall resulting in the disorganization of the hurricane structure followed by its weakening and, possibly, disintegration.

### Example Target Hurricane

Hurricanes and intense storms are organized mushroom like structures with a head and a hollow cylindrical stem. The hollow center is referred to as the eye, where the wind speed is minimal. The eye is surrounded by a zone of fast flowing air referred to as the eye wall. The eye wall structure is the major contributor to the strength of a hurricane and disintegration of the eye wall by interruption with its formation or maintenance is expected to result in the dissipation of the mushroom head as well.

A low-end category 4 hurricane with a wind speed of 135 miles per hour (mph) at the eye wall (=60 meters/sec, m/s) is used in this example. The stem of the hurricane is considered to be a hollow cylinder for calculations.
Eye diameter=20 miles and a circumference=^{˜}60 miles (=100 kilometers, km)
Height of the eye wall=50,000′ (^{˜}10 miles)
Size of the rim of the eyewall=2 miles (^{˜}3 kms)

### Rationale for the Use of Liquid Nitrogen:

There are several conditions that are required for the formation and strengthening of a hurricane over the ocean. The most important of these is that the surface temperature of the water should be at least 80° F. At temperatures below this, the water is too cold for the formation and sustenance of hurricanes.

The fact that the hurricane season in the northern Atlantic Ocean extends from June through November is mainly explained by this factor. The hurricane eye wall itself consists of a zone of fast flowing down draft along the inner wall which hits the warm water surface and kicks up bands of moisture laden air that rise up along the outer wall in a clock wise direction. This is the main mechanism that leads to the sustenance and strengthening of hurricanes. Hence, a localized cooling of the water surface along the path of the hurricane would be expected to impede the formation and/or sustenance of the hurricane eye wall.

Cooling of the ocean water surface could be achieved by several methods. These include the use of cold solids such as ice blocks/bergs, cold or super cold liquids and liquefied or solidified gases. The use of cold solids such as ice bergs presents challenges in transportation and is not practical. The use of cold sea water pumped up from the depths to the surface has been proposed in a patent application by a different group but not in the manner proposed here to cool the water surface in the path of an advancing hurricane. The volumes of water to be pumped would also be enormous and it might not be practical to pump out the volume of water necessary to have an effect. The use of liquefied or solidified gases appears to be the best solution.

The use of liquefied or solidified gases has the advantage that compared to cold solids and liquids, relatively much smaller amounts would be needed to achieve the desired drop in the temperature of the water surface, as the temperature of these substances tend to be extremely low. This would allow a relatively small amount of the liquefied or the solidified gas to cool down a much larger volume of the water at the ocean surface as well as the air above it.

The use of liquefied gases has an advantage over the solidified gases in that the liquids can be dispersed more easily as a spray than solids. Further, liquefied gases boil and get converted to gas much faster than solidified gases, which is another great advantage.

The use of liquefied gas has an added advantage. In addition to the requirement that the water temperature at the ocean surface be greater than 80° F., it is also necessary that there be no wind shear in the atmosphere for the hurricane to sustain itself. When the liquefied gas is sprayed at the water surface, it rapidly boils over creating a cloud of super cold gas. This cloud is much denser than the surrounding air and therefore moves at a slower speed than the surrounding air. This creates vortices and wind shear, which cause turbulence and disrupt the air flow in the eye wall thus disturbing its structure. The cloud of the super cold gas also is also dry and causes condensation in the nearby zones as it spreads which results in a localized reduction in the amount of moisture carried by the rising warm air bands. This could lead to the disruption of the contiguous cloud formation in the mushroom head of the hurricane, thus weakening it. It is possible that this mechanism of action could result in the actual dissolution of the hurricane due to the entropy created.

As for the identity of the gases to be used, it is proposed that liquefied form of any gas could be used. Liquid nitrogen is proposed as the best gas here for reasons described below. Liquefied air, which is a mixture of approximately 80% nitrogen and 20% oxygen, would probably work equally well. The use of gases which are not normal components of the atmosphere could be problematic in that the long term of effects of these gases in the atmosphere would have to be understood and mitigated.

### Advantages of Liquid Nitrogen:

Using liquid nitrogen to cool the water surface has the following advantages:
1. Liquid nitrogen is cheap to produce and the technology to produce it has been around for over a hundred years
2. Nitrogen is a naturally occurring and abundant gas forming approximately 80% of the atmosphere by volume
3. Production and use of liquid nitrogen results in neither a net decrease nor a net increase in its atmospheric ratio in the long run; hence, no deleterious effects would be expected on the climate from its use
4. Liquid nitrogen has a wide variety of industrial use and the knowledge base on its use and handling is vast
5. Liquid nitrogen stays liquid at a temperature of −196° C. (−325° F.). Hence, 1 kg of liquid nitrogen can cool down approximately 80 kg of sea water or 80 kg of air from 80° F. to 75° F. Since the density of air is approximately 1 kg/M³, it would be equivalent to 80 M³ of air

### Amount of Liquid Nitrogen Needed:

It is proposed that the liquid nitrogen is sprayed along the advancing inner border of the rim of the eye wall in an area covering about ⅓ of the inner circumference of the eye wall. This would be equivalent to about a ^{˜}33 km stretch of the eye wall. It is proposed to spray liquid nitrogen on the entire width of the eye wall, which would be 2 miles (^{˜}3 km) to a depth of 1 cm.

Hence, the area to be spread would be 33 km×3 km=100 km 2=100×10⁵×10⁵=10¹² cm2

The volume of the liquid nitrogen to be sprayed would be, 10¹² cm²×1 cm=10¹² cm³

This would be equivalent to a billion (10⁹) liters of liquid nitrogen.

Currently, liquid nitrogen retails for less than $100 for a 230 liter tank, which includes the cost of delivery, handling, labor involved and the profit margin of the vendor. So, it is expected that the cost of production would be in the order of about 10 liters per dollar. With this cost scenario, the cost of the liquid nitrogen would be about $100 million.

The above calculations are for a low-end category 4 hurricane on the Saffir-Simpson scale. It is expected that the amount of liquid nitrogen needed would be much lower if the intervention were performed when it is still a tropical storm or a category 1 hurricane well away from the coast.

### Method of Deployment:

The liquid nitrogen would be sprayed along the inner rim of the eye wall of the advancing hurricane at the ocean surface using submarines. If spraying at the surface becomes impossible due to the choppiness of the ocean surface, the liquid nitrogen could be released below but as close to the surface as possible. In this scenario, the submarines would submerge well away from the hurricane to a depth below the choppy waters and rise to, or close to, the surface inside the eye. The wind speed in the eye wall is usually very minimal and even though the water at the surface might be choppy next to the rim, the waters should be manageable at a distance of a few hundred feet from the hurricane rim. Since the submarines can submerge to a depth of several hundred feet, it should be safe for them to cross the eye wall under water where water disturbance is expected to be only a few hundred feet, if at all. The submarines can carry the liquid nitrogen in their tanks on board and ferry supplies from a super tanker parked outside or following the hurricane from behind. Alternatively, they can have the liquid nitrogen manufacturing units on board.

### CLAIMS AND EMBODIMENTS

What is claimed is a method for weakening or disintegrating a hurricane by:

Claim 1—cooling the surface of the ocean along the inner rim of the hurricane eye wall

Claim 2—disrupting the flowing air by creating entropy by the clouds of heavy cold gas created by spraying liquefied gases along the inner rim of the eye wall at the ocean surface

The following embodiments are proposed:
1. In its simplest embodiment, liquid nitrogen will be sprayed along the inner rim of the hurricane wall
2. In an alternate embodiment, liquefied air will be sprayed along the inner rim of the hurricane wall
3. In an alternate embodiment, the liquefied form of any gas can be used to spray along the inner rim of the hurricane wall
4. In an alternate embodiment, the liquefied form of any gas can be released beneath the inner rim of the hurricane wall
5. In an alternate embodiment, solidified form of any gas, for example carbon dioxide, will be dispersed along the inner rim of the hurricane wall
6. In an alternate embodiment, any cold liquid will be sprayed along the inner rim of the hurricane wall
7. In an alternate embodiment, cold sea water pumped up from a suitable depth will be sprayed or discharged along the inner rim of the hurricane wall

Finally, it should be realized that targeted cooling of the ocean surface on the path of the advancing hurricane by any means could be used to make the conditions unfavorable for hurricane formation/sustenance/strengthening, and disrupt the flow of air as a means to reduce or eliminate the destruction caused by flowing air. It should also be noted that the term hurricane has been used throughout this patent application; it would also include the same phenomena of high-speed winds such as typhoons, cyclones, etc.

What is claimed is a method for weakening or disintegrating a hurricane by:

1. Cooling the surface of the ocean along the inner rim of the hurricane eye wall.

2. Disrupting the flowing air by creating entropy by the clouds of heavy cold gas created by spraying liquefied gases along the inner rim of the eye wall at the ocean surface.

3. In its simplest embodiment, liquid nitrogen will be sprayed along the inner rim of the hurricane wall.

4. In an alternate embodiment, liquefied air will be sprayed along the inner rim of the hurricane wall.

5. In an alternate embodiment, the liquefied form of any gas can be used to spray along the inner rim of the hurricane wall.

6. In an alternate embodiment, the liquefied form of any gas can be released beneath the inner rim of the hurricane wall.

7. In an alternate embodiment, solidified form of any gas, for example carbon dioxide, will be dispersed along the inner rim of the hurricane wall.

8. In an alternate embodiment, any cold liquid will be sprayed along the inner rim of the hurricane wall.

9. In an alternate embodiment, cold sea water pumped up from a suitable depth will be sprayed or discharged along the inner rim of the hurricane wall.

10. Finally, it should be realized that targeted cooling of the ocean surface on the path of the advancing hurricane by any means could be used to make the conditions unfavorable for hurricane formation/sustenance/strengthening and disrupt the flow of air, as a means to reduce or eliminate the destruction caused by flowing air.

11. It should also be noted that the term hurricane has been used throughout this patent application; it would also include the same phenomena of high-speed winds such as typhoons, cyclones, etc.
